(19) United States
(12) Patent Application Publication
(10) Pub. No.: US 2005/0137836 A1
(43) Pub. Date: Jun. 23, 2005

(54) Computer system architecture transformation

(76) Inventors: Noel E. Clark, Bay City, MI (US); Terry J. White, Westland, MI (US)

Correspondence Address: FISH & RICHARDSON P.C., 1425 K STREET, N.W., 11TH FLOOR, WASHINGTON, DC, 20005-3500, US

(21) Appl. No.: 10/744,707

(22) Filed: Dec. 23, 2003

(51) Int. Cl. G06F 17/50

(52) U.S. Cl. 703/1

(57) ABSTRACT

Computer system architecture transformation may be accomplished by a variety of techniques. In certain implementations, a transformation technique includes analyzing a computer system architecture to determine functions of software applications and relationships between components and determining actual use of the components by non-architecture actors. The transformation technique also includes determining how to partition the components into modules that correlate with the actual use of the architecture components and determining collaboration between the modules.

### TECHNICAL FIELD

This description relates to computer systems, and more particularly, to computer system architectures.

### BACKGROUND

Most organizations have a large number of software applications to perform a variety of important tasks. Examples of tasks performed by software applications include payroll, human resources, purchasing, warehousing, sales, and customer relationship management. Such applications may become restrictive after time, particularly with respect to their ability to interoperate with other software applications and computer hardware that the organization may later acquire. For example, procedural applications (i.e., those that execute their logical statements in a sequence) may have a difficult time interoperating with object-oriented applications. Procedural applications also may be unable to take advantage of advances in technology.

Various methodologies have been developed to analyze and transform older software applications so that the applications may interoperate with newer software applications and computer hardware. The methodologies may include analyzing the older software applications to assess the application portfolio as a whole, as well as the quality and viability of software applications to perform in a modernized computer system architecture. This may involve manual review of software application documentation and code of an organization, and may also involve interviews with experts at the organization. The methodologies may also include translating software applications written in older programming languages (e.g., COBOL, PL/1, or FORTRAN) to more modern programming languages (e.g., Java, C/C++, or C#). Various computer programs have been developed for automatically performing such translations. The methodologies may additionally include discovering and describing the business fuictions that the software applications perform. Using these techniques, the business functions in older software applications may be identified and reused in future versions of the software applications.

### SUMMARY

Techniques are provided for transforming computer system architectures. In one general aspect, computer system architecture transformation includes analyzing a computer system architecture to determine functions of software applications and relationships between components, such as, for example, the software applications and resources. The transformation also includes determining actual use of the components by non-architecture actors, such as, for example, users, and determining how to partition the components into modules based on the actual use of the architecture components. The transformation additionally includes determining collaboration between the modules.

In certain implementations, analyzing a computer system architecture to determine functions of software applications includes determining business logic therein. Determining actual use of the components by non-architecture actors may include determining the conditions upon which the actors interact with the architecture components.

Determining how to partition the components into modules may be based on the components' functions and relationships, and may include determining the affinity of the functions and components for each other.

Determining collaboration between the modules may include determining the sequence of messaging required to accomplish an organization task. Determining collaboration between the modules also may include establishing a message broker for routing messages between the modules.

Particular implementations may include determining a message protocol to allow the collaboration. Additionally, some implementations may include mapping the modules and collaboration therebetween to a distributed-object architecture.

In another general aspect, transforming a computer system architecture includes analyzing a computer system architecture to determine functions of software applications and relationships between components and determining actual use of the components by non-architecture actors, including the conditions upon which the actors interact with the architecture components and the conditions upon which the actors process data received from the architecture components. The transformation also includes determining how to partition the components into modules based on the components' functions and relationships, the actual use of the components, and the affinity of the functions and the components for each other. Additionally, the transformation includes determining collaboration between the modules, where determining collaboration includes determining the sequence of messaging to accomplish an organization task and establishing a message broker for routing messages between the modules. The transformation further includes determining a message protocol to allow the collaboration and mapping the modules and collaboration therebetween to a service-oriented architecture.

The details of one or more implementations are set forth in the accompanying drawings and the description below. Other features will be apparent from the description and drawings, and from the claims.

### DESCRIPTION OF DRAWINGS

FIG. 1 is a flow chart illustrating a process for computer system architecture transformation.

FIG. 2 is a block diagram illustrating a computer system architecture transformation.

FIG. 3 is a flow chart illustrating a process for module messaging.

FIGS. 4A-4B are diagrams illustrating a use case for computer architecture transformation.

FIGS. 5A-5B are diagrams illustrating a modification to the use case in FIGS. 4A-4B.

FIG. 6 illustrates an object class for an object-oriented application of the use case in FIGS. 5A-5B.

FIG. 7 is a flow diagram illustrating a collaboration process for the use case in FIGS. 5A-5B.

FIG. 8 illustrates a message protocol for the collaboration process in FIG. 7.

Like reference symbols in the various drawings indicate like elements.

DETAILED DESCRIPTION

Computer system architecture transformation includes analyzing existing computer system components and their use to identify the functions and relationships between the components and to determine the actual use of the components. Transformation also may include determining how to partition the components into modules based on their functions, relationships, and actual use, and determining the collaboration between modules. The modules may be mapped, for example, to a distributed object architecture. The transformation is useful for enhancing the performance and upgradability of a computer system architecture. Computer system architecture transformation may, however, include a variety of other techniques.

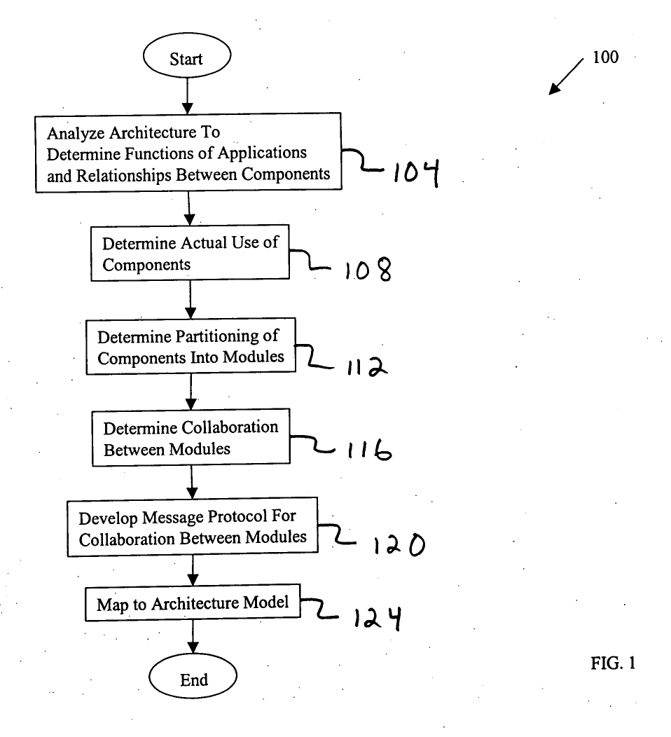

FIG. 1 illustrates a process 100 for computer system architecture transformation. The process includes analyzing a computer system architecture to determine functions of software applications and relationships between components including software applications and resources (operation 104). The process also includes determining the use of the components (operation 108), determining how to partition the components into modules (operation 112), and determining collaboration between the modules (operation 116). The process additionally includes developing a message protocol for collaboration between the modules (operation 120) and mapping the modules to an architecture model (operation 124). By using process 100, a computer system architecture may be transformed from a procedural-based architecture to a distributed-object architecture, such as, for example, a service-oriented architecture.

In more detail, analyzing a computer system architecture to determine functions of software applications and relationships between components (operation 104) may be performed by any of a variety of techniques. For example, software applications and resources may be inventoried and relationships between the components—which may include, for example, the software applications, the resources (e.g., databases and printers), jobs that run the software applications, and/or any other appropriate computer system element—may be modeled, with the components and relationships being part of the computer system architecture. The relationships may be modeled, for example, using linked lists, cross references, trees, and/or chains. Based on the modeling, business views, process views, technical views, and data views may be developed. As a result of this operation, the technical relationships between the components may be understood. The analysis process may be performed, at least on in part, by various automated tools, such as, for example, Rescueware/Modemization Workbench from Relativity Technologies, Inc. (“Relativity”) of Raleigh, N.C., Next Generation Multi-Language PC-Based Software Understanding & Transformation Technology from The Software Revolution, Inc. (“TSRI”) of Kirkland, Wash., Cogen 2000™ from Electronic Data Systems Corporation (“EDS”) of Plano, Tex., and WebSphere® from IBM Corporation of Armonk, N.Y. In some implementations, the analysis may be augmented or performed entirely by hand.

The analysis may also include determining each software application's organization logic, internal technical operations, interfaces, and data needs. The organization logic includes the logic used to perform the organization's tasks. In particular implementations, this may be business logic. The data needs may be provided by databases, other software applications, or any other appropriate architecture component. Process and data views may result from this determination. Tools from companies such as Relativity, TSRI, EDS, and IBM may also assist in this aspect of the analysis, although some of the analysis may still be performed by hand.

The analysis may be used to understand the strengths and weaknesses of each function of a software application in terms of its suitability to meet current and planned business needs. Furthermore, areas of risk in the existing software application portfolio may be identified. Also, objective industry standards may be used to determine the quality of a software application. From the standards, areas for improvement, rationalization, re-platforming, reengineering, and replacement may be identified.

Determining actual use of the components (operation 108) may also be accomplished by any of a variety of techniques. For example, the analysis may include interviewing knowledgeable users in the organization and/or monitoring workers to determine how the software applications and resources are actually used. Knowledgeable users may be identified, for example, by organization function, such as, for example, system, technology, and supply chain. Based on the gathered information, a system model of use cases may be developed. The use cases may be modeled using a modeling language such as the Unified Modeling Language (UML). Application software such as Rational Rose may assist in this modeling. The architecture components may be used by people and/or other non-architecture components.

Examples of information extracted from determining the actual use of the components includes determining the pre-conditions that cause a person, or other non-architecture entity, to interact with the architecture components, how the person interacts with the architecture components, and the post-conditions according to which a person handles information from the architecture components.

For instance, if a customer decides he wants to order cellular phone service, he first decides on the features (e.g., call group, pick-up group, call forwarding) that he wants. After deciding on the features, he places a call to a call center agent who directly interacts with the architecture components. The call center agent picks up the call and, after speaking with the customer, initiates a process to complete the service order. After the service order is complete and verified, the call center agent activates a process to fulfill the order, which may include provisioning for the cellular phone service and arranging the shipment of a phone to the customer. Furthermore, upon receipt of the phone, the customer may have to register the phone, and the phone may interact with the cellular system to make sure that service is acceptable.

The preconditions for the interaction with the architecture components in this example include the customer deciding that he wants a phone, the customer determining the features desired, the customer placing a call to request the service, the call center agent understanding what services the customer wants, and the call center agent knowing what services are available. The interaction of a person with the architecture components includes the call center agent arranging the provisioning and the delivery of the telephone. The post-conditions include the customer receiving the telephone and desiring to use it, which may actually turn into preconditions for another interaction with the architecture components.

At the end of operations 104 and 108, a description that encompasses the architecture components, the actors that interact with those components, the triggers that cause actors to interact with the components, and the processing of results may be generated. Actors may include people, devices, systems, or any other appropriate entities that interact with the architecture components.

Determining the partitioning of the components into modules (operation 112) may be accomplished on the basis of the component's functions, relationships, and/or actual use. As one example, the operations that are associated with a use case may be grouped together into a module. As another example, the operations that are associated with a specific task in an organization (e.g., purchasing, warehousing, or payroll) may be grouped together. This may achieve efficiencies by not requiring calls to multiple software applications or resources to perform a single operation. Also, this may create reusable modules that can be reengineered to include commercial off-the-shelf hardware or software components. Appropriate software components are available from companies such as SAP, PeopleSoft, i2, and Oracle. As an additional example, the operations may be grouped based on their affinity (e.g., why they communicate, how often they communicate, and how long they communicate). Also, redundant operations may be eliminated, and refactoring techniques may be used.

The partitioning may result in the original architecture components being recombined, eliminated, and/or supplemented. During these operations, however, the organization logic from the original architecture system is maintained, although it may be reorganized.

The partitioning assigns the responsibilities of organization tasks to each new module. Note, however, that some of the responsibilities may be assigned to users. Furthermore, the responsibilities may be mapped to layers, such as, for example, data, application, and reporting. The responsibilities may be partitioned around these layers to make sure that appropriate interfaces are addressed. Note that some interfaces may not be entirely technological, as users may be involved.

During the partitioning operation, opportunities for improvement may be addressed. For example, items such as how an organization communicates with its workforce or suppliers may be improved from traditional techniques that usually call for waiting for an employee to contact a central server to using e-mail, Extensible Markup Language (XML), or Simple Object Access Protocol (SOAP) to send information to employees. Furthermore, instead of just sending information to an employee, items may be placed in calendars and work queues, and mobile access may be provided. Accordingly, the partitioning operation may take advantage of chances to automate or simplify operations.

In particular implementations, the modules may be implemented using object-oriented programming techniques. For these techniques, classes, objects, and methods may be defined. This may be accomplished by determining what is common among a class, breaking the class down to the data level, and determining methods to change the data may. The levels may become the system components that are part of the partitioned application modules. Outputs of this process may include a class view, that may be used to observe objects and classes.

Process 100 also includes determining collaboration between the modules (operation 116). Because the functions of the components may now be distributed between various modules, passing data between functions and resources may be more complex, particularly for functions that previously were in the same software application. Thus, the collaboration between the modules should be analyzed. The collaboration may include how the newly modeled components use each other and how they communicate with each other. This may be performed, for example, for the use cases. During the collaboration modeling, the exposed interfaces that allow modules to communicate with each may be determined. The interfaces may be published so that messages will conform to them. In an object-oriented architecture, the components may interact with each other by invoking methods of each other's objects. Results of the collaboration determination may include a collaboration view, which is a sequence diagram that shows the messaging between components and interactions with the components over a period of time.

Once the collaboration between modules has been determined, a message protocol may be developed to allow collaboration between the modules (operation 120). The message protocol may include message formats and transfer between the modules. The message protocol may be important to application partitioning and to properly defining system boundaries (e.g., classes), as well as to enabling the transformed application to continue to provide reliable, efficient, and effective interfaces to other parts of the transformed and modernized architecture. In particular implementations, the message protocol includes a message broker that acts to route messages between appropriate modules. A message and message protocol view may be generated as a result of this operation.

Once the new modules have been identified and communication between them has been developed, the modules may be mapped to a new architecture (operation 124). The mapping may be performed by analyzing the physical understanding of the computer system, the system modeling, information technology (IT) standards and practices, and identified system boundaries in view of an architecture model. In particular implementations, the new architecture may be a service-oriented architecture (SOA), or another distributed-object architecture. Software packages like Rational Rose or packages from vendors like IBM, Relativity, and Zachman International may be used to perform this mapping. Mapping the modules may assist in identifying interfaces to application boundaries, encapsulating application components, and enabling the new architecture.

Once the new architecture has been mapped, other tools may be used to regenerate new code from the old software applications. Regeneration applications are available from companies such as Texas Instruments, Microfocus, and EDS. In particular implementations, the Net Migration Factory from EDS may be used. Also, other software applications may be chosen to fill in holes in the architecture.

Process 100 has a variety of features. For example, operation 108 allows an understanding of how an organization actually uses a computer system. This may be useful for eliminating operations, automating operations, and/or finding other efficiencies. As another example, understanding the scope of a system allows designers to more readily take advantage of new technology, such as, for example, platforms and communication techniques. As a further example, responsibilities may be partitioned around logical boundaries to achieve efficiencies and still move software applications and resources to new technology. As a further example, process 100 allows for tracing of original system architecture components and operations to the new system architecture. This may be important for understanding where in the new system operations of the old system are occurring. Furthermore, having interfaces for the new modules is beneficial so that other modules cannot directly change data in a database. That is, an application module is in control of data that it owns. This may result in easier testing, as problems may be isolated.

In particular implementations, process 100 allows the transformation of legacy systems and/or leveraging of organization logic. In particular, the process facilitates modernization to distributed architecture systems by allowing an understanding of the raw operations of a computer system architecture, the scope of business transactions, and interactions, to take advantage of new technology. Use of the process allows a procedural system, where possibly all of the software applications are on one platform, to be transformed to a distributed architecture (e.g., a service-oriented architecture) that may have multiple platforms. Moreover, a view of the distributed architecture may be developed.

Although FIG. 1 illustrates a process for computer system architecture transformation, other implementations may include fewer, additional, and/or a different arrangement of operations. For example, operations 104 and 108 may be performed in parallel. This may assist in reducing the transformation development time. Additionally, a message protocol may not have to be developed for collaboration between modules (operation 120) if a standard messaging protocol may be used. As an additional example, the mapping to the new architecture module may not be required.

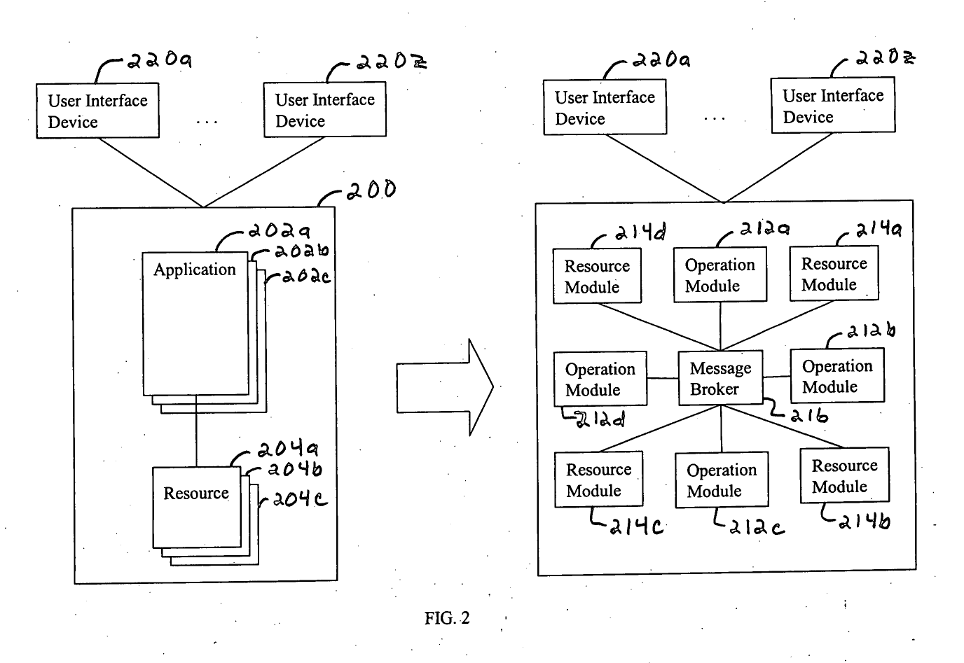

FIG. 2 illustrates the transformation of a first computer system architecture 200 to a second computer system architecture 210. This transformation may occur according to the process illustrated by FIG. 1.

Computer system architecture 200 includes software applications 202 and resources 204. Software applications 202 may perform any number of operations for an organization, such as payroll, human resources, warehousing, sales, purchasing, and customer relationship management, with one or more of these operations being performed by each software application. Resources 204 may store any kind of data and/or provide any kind of services for software applications 202. Resources 204 may be, for example, databases. Software applications 202 and resources 204 are often maintained on a single platform, such as a server.

Users interact with computer system architecture 200 through user interface devices 220. Interacting may include initiating applications 202, providing directions and/or data to applications 202, and receiving data from applications 202. User interface devices 220 may be personal computers (PCs), personal digital assistants (PDAs), work stations, cellular telephones, or any other appropriate devices for receiving data, presenting it to a user, and receiving input from the user. In particular implementations, user interface devices 220 visually present information to users by using a display and a browser, such as, for example, Microsoft™ Internet Explorer or Netscape™ Navigator. User interface device 220 may interact with computer system architecture 200 by entering into a client-server relationship with computer system architecture 200.

Computer system architecture 210 includes operation modules 212, resource modules 214, and a message broker 216. As with computer architecture 200, users interact with computer architecture 210 through user interface devices 220 to perform organization operations. However, computer system architecture 210 is organized and operates in a different manner than computer system architecture 200.

Operation modules 212 are formed by the reorganization of the functions and/or operations of applications 202. One or more of operation modules 212, however, may be similar to one of software applications 202. Furthermore, one or more of software applications 202 may have been eliminated. Additionally, one or more of operation modules 212 may be a new software application, the need for which was identified during the transformation.

Similarly, resource modules 214 are formed by the reorganization of resources 204. One or more of resource modules 214, however, may be similar to one of resources 204, and one or more of resources 204 may have been eliminated. Furthermore, one or more of resource modules 214 may be a new resource, the need for which was identified during the transformation.

Operation modules 212 and resource modules 214 are typically maintained on multiple platforms, although they may be on a single platform. The platforms may be collocated or distributed. If distributed, the platforms may be interconnected by one or more communication networks, such as, for example, a Local Area Network (LAN), a Wide Area Network (WAN), or the Internet.

Message broker 216 is responsible for the flow of messages between operation modules 212 and resource modules 214. In distributed object architectures, a module often does not understand which modules desire to receive messages from it. Moreover, even if a module understands which modules desire to receive messages from it, the module may not understand where those modules are located or know how to address them. It is the task of message broker 216, therefore, to deliver messages to the appropriate modules.

In particular implementations, the delivery may be accomplished by having the modules register with the message broker. During the registration, the modules may specify the types of messages in which they are interested. Then, when the message broker receives a message, the broker may place the message in an appropriate queue for the registered modules, which may examine the queue to retrieve their messages. Issues regarding message formats may be resolved by each requesting module using XML and SOAP techniques.

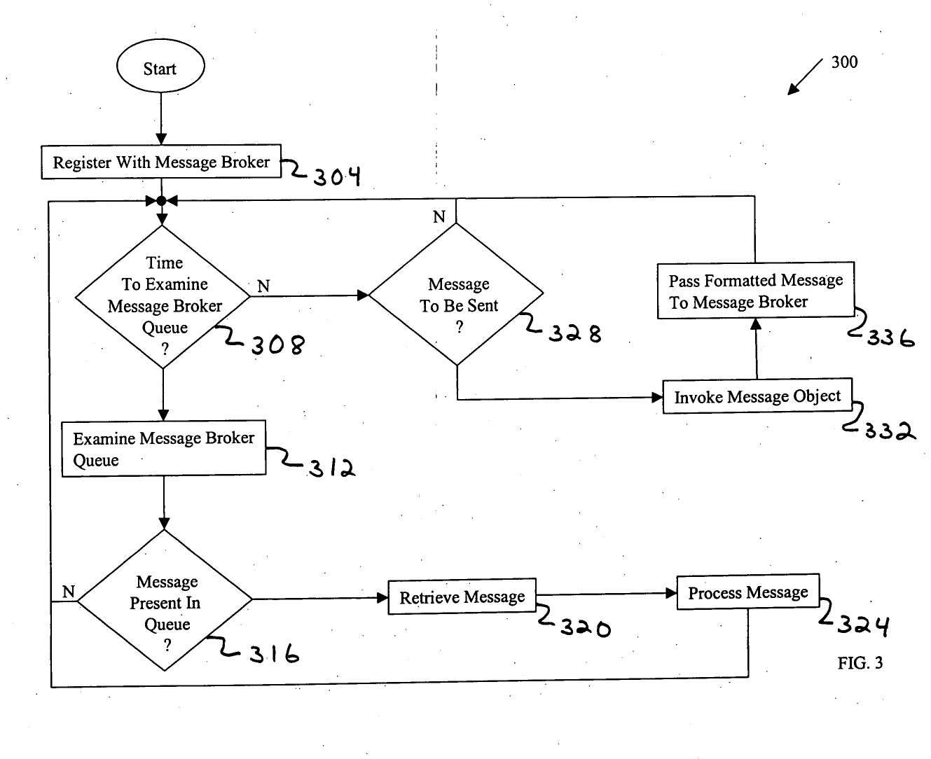

FIG. 3 is a flow chart illustrating a process 300 for module messaging. Process 300 could describe the operations of a module in computer architecture 210 in FIG. 2.

The process begins with registering with a message broker (operation 304). Registering with a message broker may include informing the message broker that the module exists and the types of messages in which the module is interested.

A determination then is made as to whether it is time to examine a message broker queue (operation 308). Determining whether it is time to examine a message broker queue may be performed when a predetermined period of time elapses, on the occurrence of an event in the module, or upon the occurrence of any other appropriate condition. If it is time to examine a message broker queue, the module examines a message broker queue (operation 312). This may be accomplished on the basis of the registration. As part of the examination, a determination is made as to whether a message is present in the queue (operation 316). If a message is not present in the queue, an additional check is made as to whether it is time to examine a message broker queue (operation 308).

If, however, a message is present, the message is retrieved (operation 320). The message may be retrieved, for example, by requesting the message from the message broker queue. The module may then process the message (operation 324).

If it is not time to examine a message broker queue, a determination is made as to whether there is a message to be sent to another module (operation 328). If there is not a message to be sent to another module, a determination is made as to whether it is time to examine a message broker queue (operation 308).

If, however, a message is to be sent to another module, a message object is invoked (operation 332). The message object may format messages for conveyance to other modules. A formatted message then is passed to the message broker (operation 336). The formatted message may be, for example, an XML message. A check then is made as to whether it is time to examine a message broker queue (operation 308).

Although FIG. 3 illustrates one implementation of a process for module messaging, other implementations may include fewer, additional, and/or a different arrangement of operations. For example, instead of examining a message broker queue, a message broker may send messages to a module. As another example, instead of invoking a message object, a module may format messages for conveyance. As a further example, a process may determine simultaneously whether it is time to examine a message broker queue (operation 308) and whether it is time for a message to be sent (operation 328).

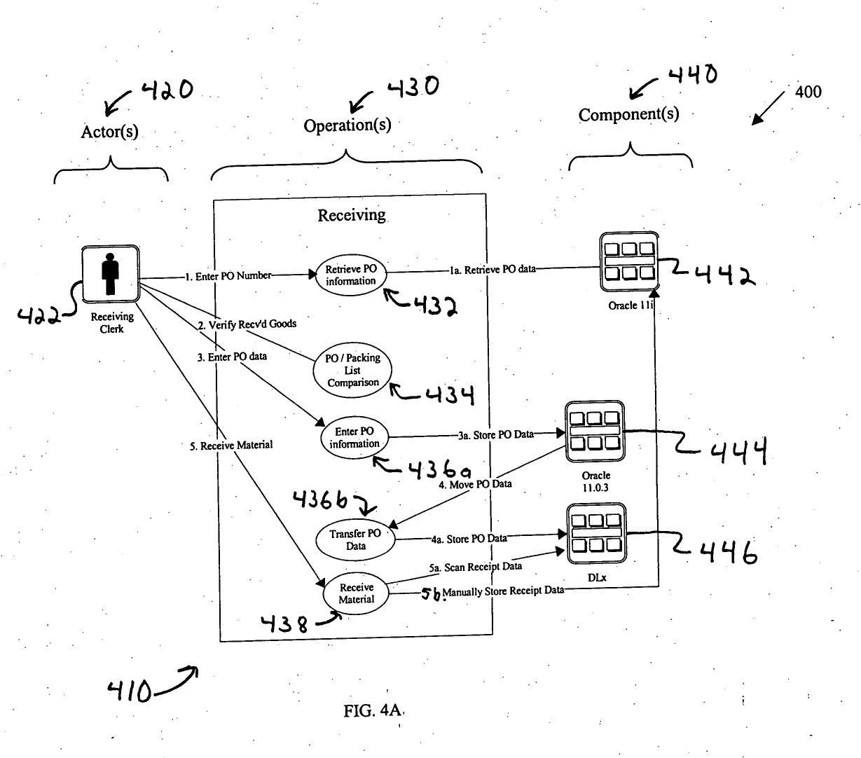

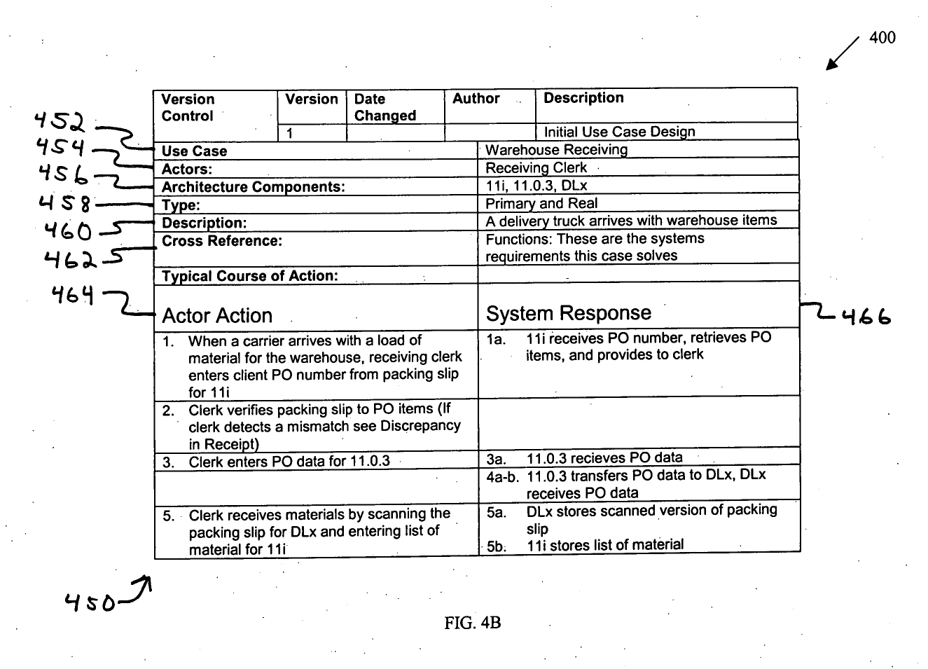

FIGS. 4A-4B illustrate a use case 400 for computer system architecture transformation. As illustrated, use case 400 includes a case flow diagram 410 (FIG. 4A) and a case description 450 (FIG. 4B) to describe the operation of a receiving task of an organization. By examining use case 400, the interoperation of a computer system architecture may be understood. Such a case may be developed during operation 108 of process 100.

Case flow diagram 410 includes an actor section 420, an operation section 430, and a component section 440. Actor section 420 includes the actors that interact with the computer system components in component section 440. Operation section 430 includes the operations performed by the actors and the components.

In the illustrated implementation, actor section 420 has one actor, a receiving clerk 422, and component section 440 has three components, a first database 442, a second database 444, and a third database 446. First database 442 is a purchasing database, and second database 444 and third database 446 are warehouse databases. Operation section 430 has five operations, purchase order (PO) data retrieval 432, PO/packing list comparison 434, PO data entry/transfer 436a-b, and material receipt 438. The operations in operation section 430 may be, for example, workgroup instructions.

In operation, the actions of the receiving clerk 422 are initiated by the arrival of a shipment for the organization, the arrival being a precondition to the receiving clerk's actions. Upon the arrival of the shipment, the clerk needs to retrieve the organization's purchase order data (operation 432). To accomplish this, the receiving clerk enters the PO number from the packing slip through an appropriate user interface, and first database 442 retrieves the purchase order. Then, the received goods may be verified by the clerk comparing the retrieved purchase order to the packing list (operation 434).

Assuming that the purchase order matches the packing list, the goods are logged into the warehouse system (operation 436). This is accomplished by the receiving clerk entering the PO data through a user interface, and second database 444 storing the data (operation 436a). Then, the second database transfers the purchase order data to third database 446 (operation 436b). Thus, the goods are logged into the warehouse.

Finally, the goods are received (operation 438). In this operation, receiving clerk 422 scans the packing slip, which is stored by third database 446, and enters the list of materials from the packing slip, which is stored by first database 442.

Like case flow diagram 410, case flow description 450 (FIG. 4B) describes use case 400. As illustrated, case flow description 450 includes a section 452 including the name of the case, a section 454 including the actors for the case, and a section 456 including the architecture components involved in the case. Thus, a user may readily identify a case, actors, and components. Case flow description 450 also includes a section 458 indicating the type of operations for the case and the type of description provided by case flow description 450, a section 460 including a description of the case, and a section 462 containing cross references for the case so that associated cases may be identified. The types in section 458 may indicate the importance of the task to the organization and the level of detail described in the case. The types may be used during design of the use case to gain agreement between the author/analyst and contributors and/or after the use case is created to give guidance to designers and to make sure they understand what is represented, and to what level of detail. Case flow description 450 additionally includes a section 464 including the actions of the actors for the case and a section 466 including the operations of the architecture components for the case. In general, case flow description 450 is similar to case flow diagram 410.

In particular implementations, the choices of types in section 458 may include: 1) primary or secondary; 2) essential or optional; and 3) real or abstract. Primary means that the use case illustrates a common process that is used every time the task is performed. Secondary means that an alternative process is illustrated for accomplishing a task. For example, use case 400 captures the operations that normally happen when a shipment of inventory arrives, and, therefore, is primary. However, another use case for this process may be invoked when, for example, the goods are found to be damaged and require inspection before receipt is acknowledged. This use case would be a secondary process to the primary process. Essential means that the illustrated process is performed every time, and optional means that the illustrated process needs to be performed sometimes. An example of an optional process is a random selection for inspection that is at the discretion of the receiving clerk. Real identifies whether the use case illustrates the complete list of operations and actors for the task, and abstract identifies whether some of the operations and/or actors are omitted. For example, it is typically not necessary to show an e-mail system's actors for a receipt use case when the system is just used to communicate outside the system boundaries, for Material Requirements Planning (MRP), for example.

Together, case flow diagram 410 and case flow description 450 describe a function of an organization so that a designer may understand the interoperation of a computer system architecture. Also, from analyzing the flow diagram and flow description, places for improvement of the actor's actions and/or the system response may be understood.

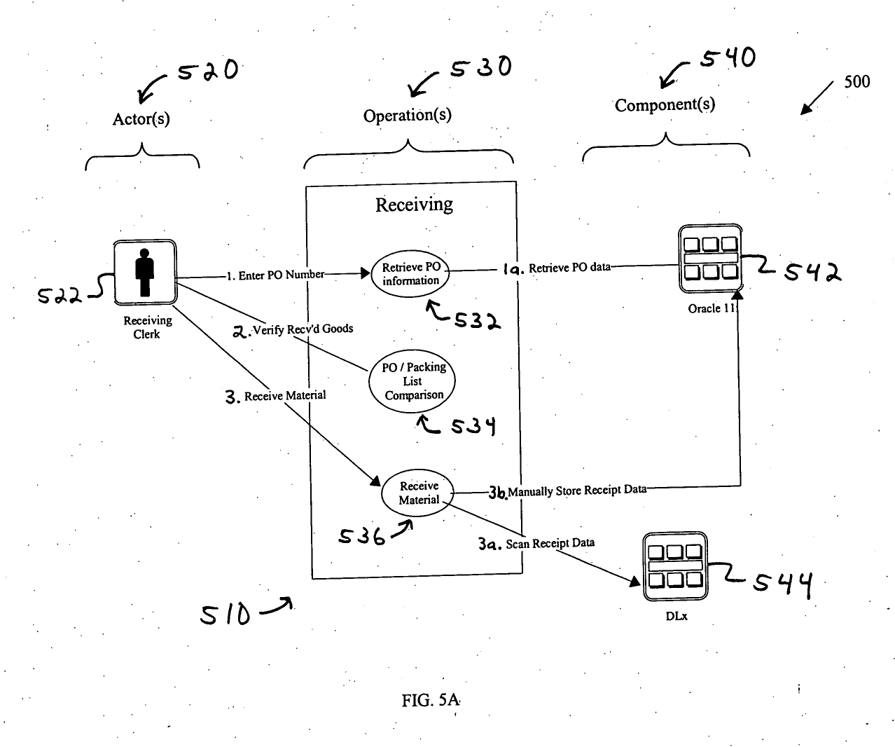

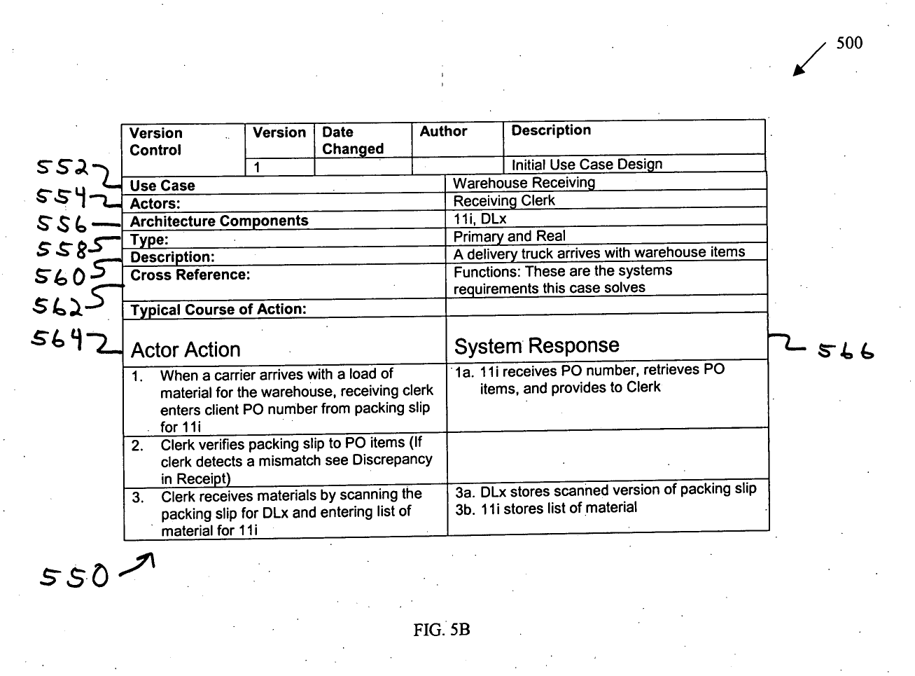

FIGS. 5A-5B also illustrate a use case 500 for computer system architecture transformation. Use case 500 is a modified, and hopefully improved, version of use case 400. That is, use case 400 documents how an architecture is currently being used, and use case 500 illustrates a new use for the architecture, possibly along with a reorganization of components. As with use case 400, use case 500 includes a case flow diagram 510 (FIG. 5A) and a case flow description 550 (FIG. SB) and describes the operation of a receiving task of an organization. By examining use case 500, the interoperation of a computer system architecture may be understood.

Case flow diagram 510 includes an actor section 520, an operation section 530, and a component section 540. Actor section 520 includes the actors that interact with the system components included in component section 540. Operation section 530 includes the operations performed by actors and components for the organization.

In the illustrated implementation, actor section 520 has one actor, a receiving clerk 522, and component section 540 has two components, a first database 542 and a second database 544. First database 542 is a purchasing database, and second database 544 is a warehouse database.

In operation, the actions of receiving clerk 522 are initiated by the arrival of a shipment for the organization, the arrival being a precondition to the receiving clerk's actions. Upon the arrival of the shipment, the clerk needs to retrieve the organization's purchase order data (operation 532). To accomplish this, the receiving clerk enters the PO number from the packing slip through an appropriate user interface, and first database 542 retrieves the purchase order. Then, the received goods are verified by the receiving clerk's comparison of the retrieved purchase order to the packing list (operation 534).

Assuming the purchase order matches the packing list, the goods are received (operation 536). In this task, receiving clerk 522 scans the packing slip, which is stored by second database 544, and enters the list of materials from the packing slip, which is stored by first database 542.

Like case flow diagram 510, case flow description 550 (FIG. 5B) describes use case 500. As illustrated, case flow description 550 includes a section 552 including the name of the case, a section 554 including the actors for the case, and a section 556 including the architecture components involved in the case. Thus, a user may readily identify a case, actors, and components. Case flow description 550 also includes a section 558 including the type of case, a section 560 including a description of the case, and a section 562 containing cross references for the case so that associated cases may be identified. Case flow description 550 additionally includes a section 564 including the actions of the actors for the case and a section 566 including the operations of the system components for the case. In general, case flow description 550 is similar to case flow diagram 510.

Comparing case flow diagram 410 to case flow diagram 510, several operations and a system component have been eliminated in use case 500 relative to use case 400. Thus, use case 500 is simpler than use case 400.

Specifically, second database 444 and operation 436 were eliminated in use case 500. The purpose of second database 444 and task 436 was to place purchase order data in third database 446, because third database 446 and first database 442 could not communicate with each other. By recognizing that this was the purpose of second database 444, a designer determined that a simplified set of components and operations could be achieved if first database 442 could communicate with third database 444. Use case 500 is the result.

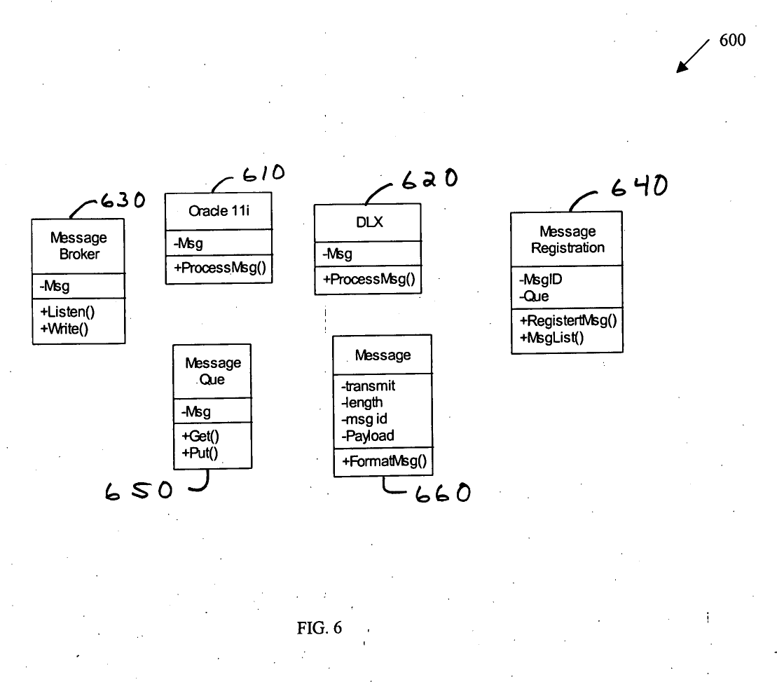

FIG. 6 illustrates an object class 600 for an object-oriented application of the use case in FIGS. 5A-5B. Note, however, that FIG. 6 may only illustrate part of the object classes for an architecture for use case 500.

As illustrated, the architecture components have each been assigned to an object. In particular, there is a first database object 610 for first database 542 and a second database object 620 for second database 544. Also, a message broker object 630, a message registration object 640, a message object 650, and a message queue object 660 have been introduced. These objects facilitate the messaging for the new architecture for use case 500.

In more detail, message broker object 630 facilitates messaging between components such as applications and databases by understanding what types of messages each object desires and placing messages of the appropriate type in queues that the objects examine. In accomplishing this, message registration object 640 is responsible for determining the desired messages of the module objects for the message broker. The desired messages may be determined by having each module object specify an identifier, which may be a sequence of letters, a sequence of numbers, a name, or any other appropriate identification symbol, for the desired messages. Each module object may have, for example, its own queue. Message registration may be performed at initiation.

After registration, the message broker may retrieve the queue and message list associations from message registration object 640. Registration and discovery of an operation module may be brokered in the process. Message queue object 650 is responsible for managing the queues required by message broker object 630. Message object 660 is a service object defined to format the messages. When an object wants to pass a message, it invokes a method of object 650, which formats the message appropriately.

As illustrated, objects 610-660 have parameters and methods to allow communication. The illustrated components also may have subclasses. For example, database object 610 may have subclasses for the message processing class of work in progress or inventory. Inventory may include an associated bill of materials, part number, and part version.

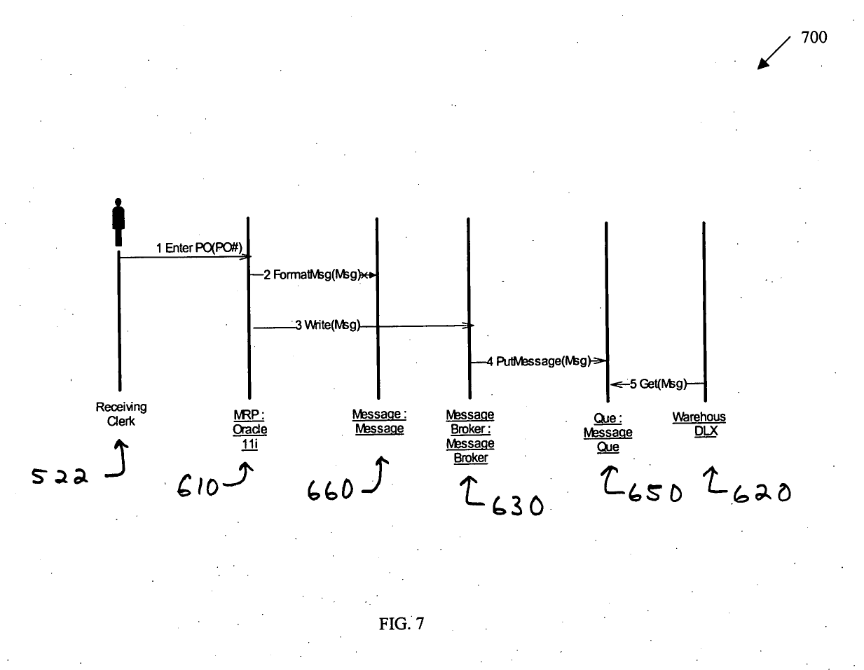

FIG. 7 is a flow diagram illustrating a collaboration process 700 for the use case in FIGS. 5A-5B, including the objects in FIG. 6. Note, however, that FIG. 7 may only illustrate part of the collaboration process.

The collaboration process begins when receiving clerk 522 needs to retrieve PO data. To accomplish this, the clerk enters the PO number using a method defined by first database object 610. First database object 610 then invokes a message object of message object 660 to format a message for second database object 620. First database object 610 then passes (e.g., writes) the formatted message to message broker object 630 as a message object. Message broker object 630 identifies the queue into which to insert the message object based on an ID field associated with the message, and queue object 650 places the message object in the appropriate queue. Second database object 620 listens to the queue and retrieves the message object from the appropriate queue. In general, after a message is received, the message is processed with existing operation methods.

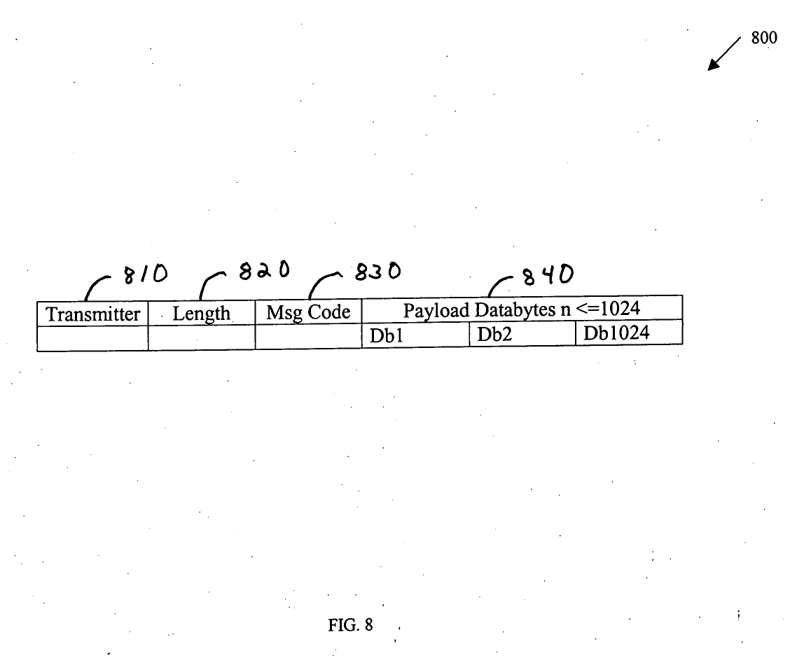

FIG. 8 illustrates a message protocol 800 for the collaboration process of FIG. 7. As illustrated, message protocol 800 includes a transmitter ID section 810, a length specification section 820, a message code ID section 830, and a payload specification section 840. Transmitter ID section 810 contains an identifier for the transmitting object class. Length specification section 820 contains an indication of the length of the message. Message code ID section 830 contains an identifier for the type of data that the message contains. As mentioned previously, a message broker may use this ID to determine where to queue a message. Payload specification section 840 contains the data of the message. As illustrated, payload specification section 840 includes up to 1024 bytes of data. In other implementations, however, any number of bytes may be in a payload specification section.

Although FIG. 8 illustrates one implementation of a message protocol, other implementations may contain fewer, additional, and/or a different arrangement of sections. Other message protocols may include, for example, a destination ID section and/or an error identification and/or correction section (e.g., checksum, parity, cyclic redundancy check, or forward error correction). Additionally, other message protocols may not include a transmitter ID section 810 or a length specification section 820. Furthermore, the sections may be in any order.

Various implementations of the systems and techniques described here may be realized in digital electronic circuitry, integrated circuitry, specially designed ASICs (application specific integrated circuits), computer hardware, firmware, software, and/or combinations thereof These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input.

The systems and techniques described here may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the systems and techniques described here), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A variety of implementations have been described in detail, and a number of other implementations have been mentioned or suggested. Furthermore, a variety of additions, deletions, modifications, and substitutions to these implementations may be made while still achieving computer system architecture transformation. For these reasons, other implementations are within the scope of the following claims.

1. A method comprising:
analyzing a computer system architecture to determine fimctions of software applications and relationships between components;
determining actual use of the components by non-architecture actors;
determining how to partition the components into modules based on the actual use of the architecture components; and
determining collaboration between the modules.

2. The method of claim 1, wherein the components comprise software applications and resources.

3. The method of claim 1, wherein analyzing a computer system architecture to determine functions of software applications comprises determining business logic therein.

4. The method of claim 1, wherein determining actual use of the components by non-architecture actors comprises determining the conditions upon which the actors interact with the architecture components.

5. The method of claim 4, wherein a non-architecture actor comprises a person.

6. The method of claim 1, wherein determining how to partition the components into modules is also based on the components' functions and relationships.

7. The method of claim 6, wherein determining how to partition the components into modules comprises determining the affinity of the functions and components for each other.

8. The method of claim 1, wherein determining collaboration between the modules comprises determining the sequence of messaging required to accomplish an organization task.

9. The method of claim 8, wherein determining collaboration between the modules comprises establishing a message broker for routing messages between the modules.

10. The method of claim 1, further comprising determining a message protocol to allow the collaboration.

11. The method of claim 1, further comprising mapping the modules and collaboration therebetween to a distributed-object architecture.

12. A method comprising:
analyzing a computer system architecture to determine functions of software applications and relationships between components;
determining actual use of the components by non-architecture actors, including the conditions upon which the actors interact with the architecture components and the conditions upon which the actors process data received from the architecture components;
determining how to partition the components into modules based on the components' functions and relationships, the actual use of the components, and the affinity of the functions and the components for each other;
determining collaboration between the modules, wherein determining collaboration comprises determining the sequence of messaging required to accomplish an organization task and establishing a message broker for routing messages between the modules;
determining a message protocol to allow the collaboration; and
mapping the modules and collaboration therebetween to a service-oriented architecture.
